(19) United States
(12) Patent Application Publication
(10) Pub. No.: US 2026/0036896 A1
(43) Pub. Date: Feb. 5, 2026

(54) PROJECTOR ASSEMBLY

(71) Applicant: HYUNDAI MOBIS CO., LTD., Seoul (KR)

(72) Inventor: Cheon Seop SHIN, Yongin-Si (KR)

(73) Assignee: HYUNDAI MOBIS CO., LTD., Seoul (KR)

(21) Appl. No.: 19/247,798

(22) Filed: Jun. 24, 2025

(30) Foreign Application Priority Data
Aug. 5, 2024 (KR) 10-2024-0103622

(51) Int. Cl. G03B 21/58; B60K 35/22; G09G 3/00

(52) U.S. Cl. CPC G03B 21/58; B60K 35/22; G09G 3/001; B60K 2360/334; B60K 2360/66; B60K 2360/771; G09G 2380/10

(57) ABSTRACT

A projector assembly according to one embodiment of the present invention may include a screen rotatably attached to a ceiling of a vehicle room and a projector disposed on the ceiling of the vehicle room to be spaced a predetermined distance from the screen, and the screen may include a first screen and a second screen which have different sizes, the first screen and the second screen are individually rotatable, the first screen may be formed to have a greater area than the second screen, an accommodation groove corresponding to a shape of the second screen may be formed in one surface of the first screen, and the second screen may be rotated toward the first screen and seated in the accommodation groove.

### CROSS-REFERENCE TO RELATED APPLICATIONS

This application claims priority to and the benefit of Korean Patent Application No. 10-2024-0103622, filed on Aug. 5, 2024, the disclosure of which is incorporated herein by reference in its entirety.

### TECHNICAL FIELD

The present invention relates to a projector assembly, and more specifically, to a projector assembly which is provided at a roof side in a vehicle to improve utilization of space and secure a luxurious appearance.

### BACKGROUND

As the amount of use of vehicles increases, and the times that users spend in vehicles increase, more apparatuses for the convenience of users are being provided in vehicles. As an example, a display apparatus may be provided, and a user can drive using the vehicle and relax at the same time while watching desired images or the like using the display apparatus.

In the conventional vehicle, although functions for convenience of a driver can be provided using a navigation, a music player, and the like provided in a cockpit module, display apparatuses can also be provided at different locations for convenience of a passenger and a driver in the case of an autonomous vehicle in which a driver is not present or the like.

Recently, a display apparatus has been provided on a rear surface of a front seat used in a vehicle such as a taxi or the like, or a display apparatus protruding from a roof side has been provided.

In the case of an apparatus applied to a roof of a vehicle, when the apparatus is not used, the apparatus is normally exposed and may restrict movement of a passenger, and even when a display in a roll type for accommodation of the apparatus is provided, since additional space is required in the roof, there is a problem that utilization of space is reduced.

The demand for a display or projector which is easily accommodated in a roof of a vehicle and is convenient for a passenger to use is increasing.

### SUMMARY

One embodiment of the present invention is directed to providing a projector assembly of which utilization of space is improved and a luxurious appearance is secured.

Objects to be solved by the present invention are not limited to the above-described objects, and other objects which are not described above will be clearly understood by those skilled in the art from the following description.

According to an aspect of the present invention, there is provided a projector assembly including a screen rotatably attached to a ceiling in a vehicle room and a projector disposed on the ceiling in the vehicle room to be spaced a predetermined distance from the screen.

The screen may include a first screen and a second screen which have different sizes, the first screen and the second screen may individually rotate, the first screen may be formed to have a greater area than the second screen, an accommodation groove corresponding to a shape of the second screen may be formed in one surface of the first screen, and the second screen may be rotated toward the first screen and seated in the accommodation groove.

First hinges may be formed at both sides of the first screen, second hinges may be formed at both sides of the second screen, the second hinges may be disposed inside the first hinges, and rotation axes of the first screen and the second screen may be colinear with each other.

The screen may be rotated toward one side, seated in a screen groove formed in the vehicle ceiling, and disposed not to protrude from the ceiling.

A thickness of the second screen may correspond to a depth of the accommodation groove formed in the first screen.

Moving rails may be formed at both sides of the screen groove, and ends of the first hinges may be movably seated in the moving rails such that the screen may move forward or rearward.

A large screen mode, in which the first screen is rotated and an image is projected to the first screen through the projector, and a small screen mode, in which the second screen is rotated and an image is projected to the second screen through the projector, may be implemented.

In the large screen mode, the second screen may be rotated with the first screen and disposed to be seated in the accommodation groove of the first screen.

When the mode is switched, the projector may adjust a direction of a projected beam according to a size of the screen.

When a distance between the screen and the projector is changed using the moving rail, the projector may adjust the direction of the projected beam according to a distance from the screen.

The projector may be attached to the ceiling to be vertically movable by a predetermined distance and may vertically move according to the size of the screen and the distance from the screen to adjust a position of the projector.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view illustrating a projector assembly according to one embodiment of the present invention;

FIG. 2 is a view illustrating a screen of the projector assembly that is accommodated according to one embodiment of the present invention;

FIG. 3 shows a view illustrating the screen according to one embodiment of the present invention;

FIG. 4 is a view illustrating hinges and moving rails according to one embodiment of the present invention;

FIG. 5 shows a view illustrating the screen that is accommodated according to one embodiment of the present invention;

FIG. 6 shows a view illustrating a projector that is controlled according to an arrangement of a first screen and a second screen according to one embodiment of the present invention;

FIG. 7 shows a view illustrating the projector of which a height is adjusted according to one embodiment of the present invention;

FIG. 8 is a view illustrating the screen that moves forward or rearward according to one embodiment of the present invention; and

FIG. 9 is a view illustrating the screen that is disposed according to a user's eyes according to one embodiment of the present invention.

### DETAILED DESCRIPTION

Since the present invention may be variously modified and have several embodiments, specific embodiments will be illustrated in the accompanying drawings and described in detail. However, this is not intended to limit the present invention to the specific embodiments, and it should be appreciated that all changes, equivalents, and substitutes falling within the spirit and technical scope of the present invention are encompassed in the present invention. In the description of the embodiments, certain detailed descriptions of the related art will be omitted when it is deemed that they may unnecessarily obscure the gist of the inventive concept.

Terms such as “first” and “second” may be used to describe various components, but the components are not limited by the above terms. These terms are used only to distinguish one component from another.

Terms used herein are only for the purpose of describing particular embodiments and are not intended to limit the present invention. Singular forms are intended to include the plural forms, unless the context clearly indicates otherwise. In the present specification, it should be understood that the terms “comprise,” “comprising,” “include,” and/or “including” used herein specify the presence of stated features, numbers, steps, operations, elements, components, and/or combinations thereof but do not preclude the presence or addition of one or more other features, numbers, steps, operations, elements, components, and/or combinations thereof.

In addition, throughout the specification, when components are “connected,” this may not only mean that two or more components are directly connected, but may also mean that two or more components are indirectly connected through other components or are physically connected and also electrically connected, or are one component even when referred to by different names according to positions or functions thereof.

In addition, when a first component is described as being formed or disposed “on” or “under” a second component, such a description includes both a case in which the two components are formed or disposed in direct contact with each other and a case in which one or more other components are interposed between the two components. In addition, when the first component is described as being formed “on or under” the second component, such a description may include a case in which the first component is formed at an upper side or a lower side with respect to the second component.

Hereinafter, one embodiment of a projector assembly will be described in detail with reference to the accompanying drawings, and in the description with reference to the accompanying drawings, components which are the same or correspond to each other will be denoted by the same reference numerals, and redundant description thereof will be omitted.

According to the trends of increasing distribution of vehicles and longer times that people spend in vehicles, the demand for apparatuses for convenience of passengers in vehicles is increasing

In the case of recent vehicles, displays or screens are applied to the vehicles for watching images and reading in the vehicles. However, since the displays or screens are applied to limited spaces in the vehicles, it is important for installation and storage to be easy and not interfere with activities of passengers. The present invention provides a projector assembly which is easily accommodated in a vehicle and easily manipulated by a passenger.

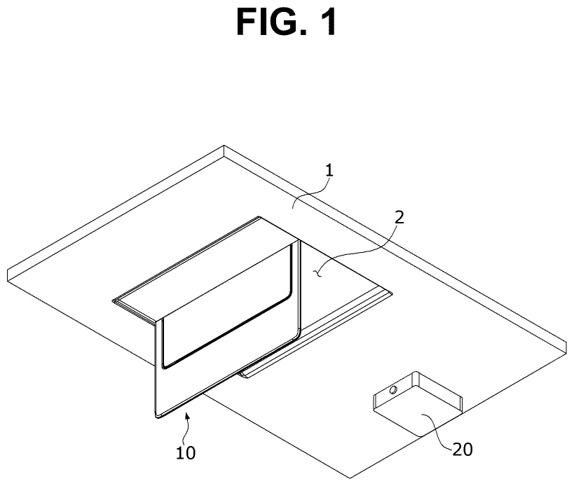

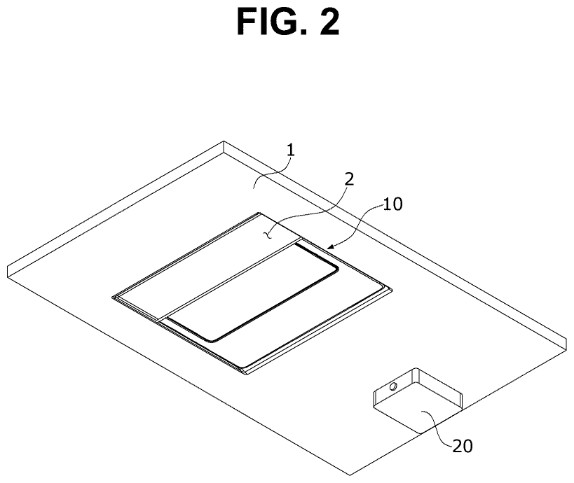

FIG. 1 is a view illustrating a projector assembly according to one embodiment of the present invention, and FIG. 2 is a view illustrating a screen of the projector assembly that is accommodated according to one embodiment of the present invention.

The projector assembly according to the present invention may be provided in a ceiling 1 in a vehicle room. Referring to FIGS. 1 and 2, the projector assembly according to one embodiment of the present invention may include a screen 10 which is accommodated in a screen groove 2 formed in the vehicle ceiling 1 and a projector 20 disposed a predetermined distance from the screen 10.

In FIG. 1, the screen 10 rotated from the vehicle ceiling 1 and disposed vertically is illustrated. The screen 10 may be rotatably provided in the vehicle ceiling 1. Accordingly, a hinge may be formed in one end portion of the screen 10, and the screen 10 may rotate about the hinge. The screen groove 2 may be formed in the vehicle ceiling 1 to accommodate the screen 10.

The screen groove 2 may be formed to be recessed in the vehicle ceiling 1 to correspond to a shape of the screen 10. The screen 10 may be accommodated by being rotated with respect to the hinge and seated in the screen groove 2 as illustrated in FIG. 2. A depth of the screen groove 2 may correspond to a thickness of the screen 10, and the screen 10 may not protrude from the ceiling 1 when the screen 10 is accommodated in the screen groove 2.

The screen 10 may be formed as a plurality of screens 10 with different sizes. The screens 10 according to one embodiment of the present invention may include a first screen 12 and a second screen 14 which have different sizes. The first screen 12 may be formed to have a greater size than the second screen 14. The number of the screens 10 is not limited, and the present embodiment including two screens 12 and 14 is one example.

The plurality of screens 10 may be connected to multiple hinges. In the case of the present invention, a first hinge 120 is formed in one end portion of the first screen 12, and a second hinge 140 is formed in one end portion of the second screen 14. The first hinge 120 and the second hinge 140 may rotate with respect to the same rotation axis. To this end, the second hinge 140 may be disposed inside the first hinge 120. That is, the first hinge 120 may be formed as a structure like a pipe, and the second hinge 140 may be disposed inside the first hinge 120 such that the first hinge 120 may rotate with respect to the same rotation axis.

Since the first screen 12 and the second screen 14 are connected to the first hinge 120 and the second hinge 140, respectively, the first screen 12 and the second screen 14 may rotate individually. That is, the first screen 12 and the second screen 14 may be provided to rotate relative to each other.

An accommodation groove 130 corresponding to a size of the second screen 14 may be formed in the first screen 12. The first screen 12 and the second screen 14 may overlap by the second screen 14 being seated in the second accommodation groove 130. Accordingly, when the first screen 12 is used, the second screen 14 may be seated in the accommodation groove 130. When the second screen 14 is used, the first screen 12 may be seated in the screen groove 2 of the ceiling 1, and only the second screen 14 may be rotated downward and disposed.

The projector 20 may be disposed the predetermined distance from the screen 10. The projector 20 may be connected to the vehicle ceiling 1 and may project a beam toward the screen 10 such that a user can watch an image or the like on the screen. The projector 20 may operate in conjunction with an external device (such as a smartphone or a notebook) and project a screen of the corresponding device. Since the projector 20 is disposed the predetermined distance from the screen 10, the projector 20 may be disposed above a passenger. The screen 10 may be disposed above and in front of the passenger so that the passenger may easily watch the image.

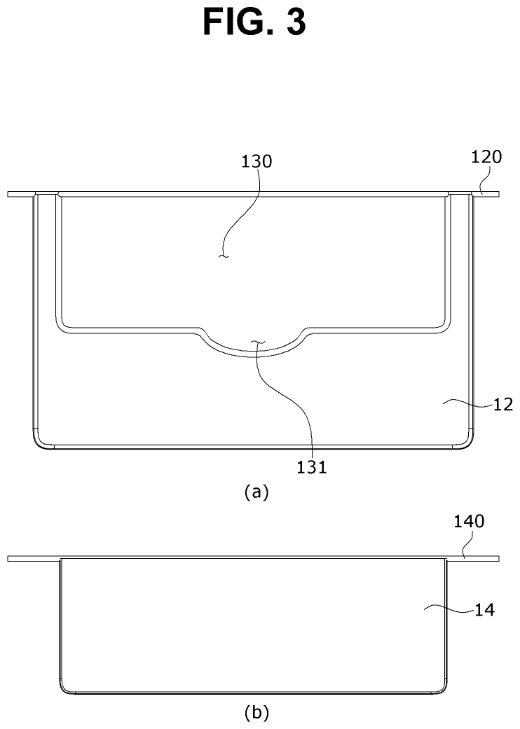

FIG. 3 shows a view illustrating the screen according to one embodiment of the present invention.

As described above, the screens 10 may be divided into the first screen 12 and the second screen 14. FIG. 3A is a view illustrating the first screen 12, and FIG. 3B is a view illustrating the second screen 14.

The first screen 12 may be formed to be greater than the second screen 14. The first screen 12 may be formed in a shape similar to a shape of the second screen 14. That is, ratios between widths and lengths thereof may be the same. Alternatively, as illustrated in FIG. 3, ratios between widths and lengths thereof may be different.

The accommodation groove 130 in which the second screen 14 is seated and accommodated may be formed in the first screen 12. The accommodation groove 130 may be formed to correspond to the shape of the second screen 14. A separate recess 131 may be formed at an edge side of the accommodation groove 130 such that the user can easily withdraw the second screen 14 from the accommodation groove 130.

The first screen 12 and the second screen 14 may be manually rotated by the passenger, and alternatively, may be electrically rotated. When the first screen 12 and the second screen 14 are electrically rotated, the recess 131 may not be formed at the edge side of the accommodation groove 130.

The accommodation groove 130 may be formed in an opposite surface of a surface of the first screen 12 facing the screen groove 2. Since the first screen 12 may be rotated to one side and accommodated in the screen groove 2, when the first screen 12 is accommodated in the screen groove 2, the accommodation groove 130 may be formed in the opposite surface of the surface facing the screen groove 2. In this case, the first screen 12 may remain accommodated in the screen groove 2, and the second screen 14 may rotate to extend downward from the ceiling 1.

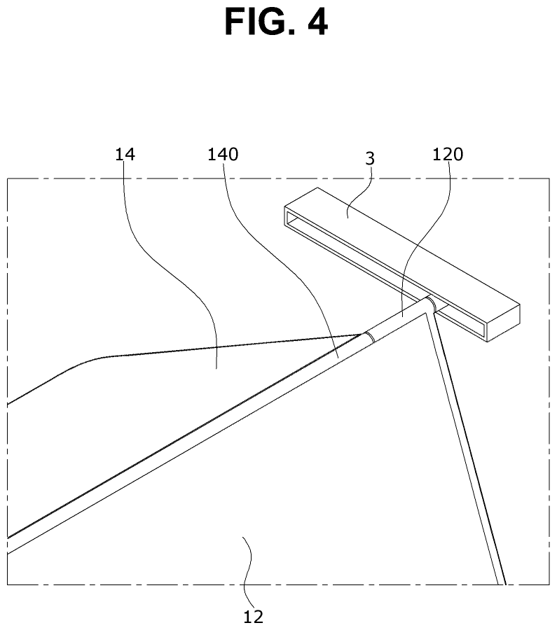

FIG. 4 is a view illustrating the hinges and moving rails according to one embodiment of the present invention.

Referring to FIG. 4, moving rails 3 may be disposed or formed at two sides of the screen groove 2 according to one embodiment of the present invention. The hinges may be seated in the moving rails 3. The first hinge 120 and the second hinge 140 are provided to rotate with respect to the same axis. To implement this, the second hinge 140 may be disposed to be inserted into the first hinge 120.

Alternatively, as illustrated in FIG. 4, the first hinge 120 may be formed to be hollow, and both end portions thereof may be formed in a pipe shape such that the first hinge 120 may rotate with the second hinge 140 with respect to the same rotation axis. The rotation axes of the first hinge 120 and the second hinge 140 may be collinearly disposed so that the first screen 12 and the second screen 14 rotate with respect to the same axis.

Both ends of the first hinge 120 may be seated inside the moving rails 3. The first hinge 120 moves inside the moving rails 3 to adjust positions of the first screen 12 and the second screen 14.

The moving rails 3 may be provided such that grooves are exposed from both side surfaces of the screen groove 2. The first hinge 120 may be seated inside the grooves. The moving rails 3 may be formed in at least portions of both side surfaces of the screen groove 2. Portions in which moving rails 3 are formed correspond to regions in which the first screen 12 and the second screen 14 may move.

The first hinge 120 may move by sliding along the moving rails 3. The method of moving the first hinge 120 may be manually or electrically performed. A component which fixes a position of the first hinge 120 may be included in the moving rails 3 such that the screen 10 is fixed at a corresponding position without moving according to movement of the vehicle.

A groove corresponding to a shape of the first hinge 120 may be formed in an inner surface of each of the moving rails 3, and the screen 10 may be disposed at a fixed position by inserting an end or side surface of the first hinge 120 into the corresponding groove. The groove may be formed as a plurality of grooves spaced a predetermined distance from each other, and the user may insert the first hinge 120 into the groove corresponding to a position desired by the user.

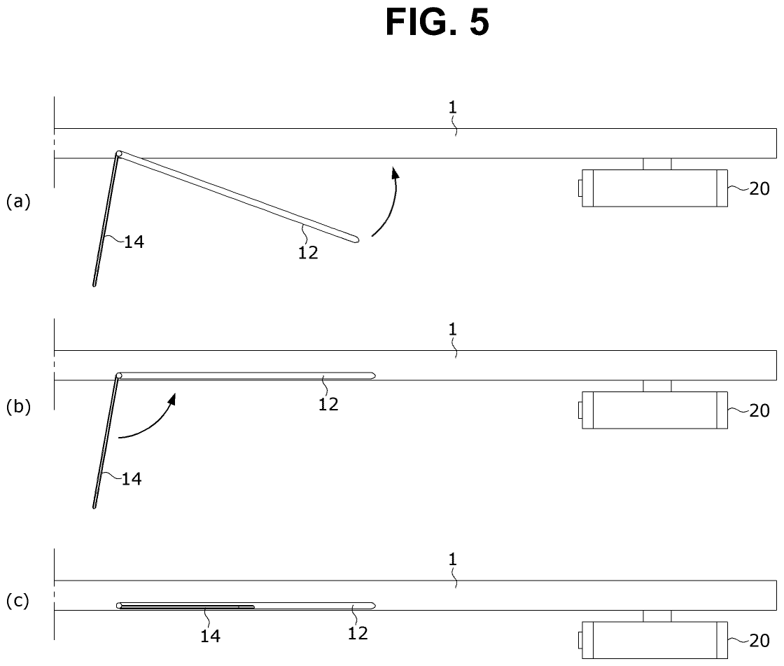

FIG. 5 shows a view illustrating the screen that is accommodated according to one embodiment of the present invention.

The screen 10 is rotated and is accommodated in the screen groove 2 in the order of FIGS. 5A, 5B, and 5C.

FIG. 5A is a view illustrating the first screen 12 that is rotated toward the screen groove 2. Since the first screen 12 and the second screen 14 may be rotated about the individual hinges, the first screen 12 may be rotated while maintaining an arrangement of the second screen 14.

Referring to FIG. 5B, it can be seen that the first screen 12 is seated in the screen groove 2. Even when the first screen 12 is seated in the screen groove 2, the second screen 14 may still maintain a fixed arrangement. When the second screen 14 is rotated in an arrow direction illustrated in FIG. 5B, the second screen 14 may be disposed as illustrated in FIG. 5C.

Since the accommodation groove 130 is formed in the first screen 12, the second screen 14 may be rotated to be seated inside the accommodation groove 130. A depth to which the accommodation groove 130 is recessed may be the same as a thickness of the second screen 14. Accordingly, when the second screen 14 is seated in the accommodation groove 130, one surface of the second screen 14 may coplanar with one surface of the first screen 12.

FIG. 5 shows the view illustrating the screen 10 that is seated in the vehicle ceiling 1. In FIG. 5C, it can be seen that the second screen 14 is seated in the accommodation groove 130 in a similar arrangement in which the second screen 14 is inserted into the first screen 12.

Although the above processes may be sequentially performed as described above, alternatively, the processes may be performed at the same time. As an example, since the first screen 12 and the second screen 14 rotate about the same rotation axis, the second screen 14 is rotated, and the first screen 12 may be rotated therewith by a force applied to the second screen 14. The first screen 12 and the second screen 14 may be rotated at the same time. That is, the second screen 14 may be rotated with the first screen 12 while seated in the accommodation groove 130 of the first screen 12.

The rotation of the first screen 12 and the second screen 14 may be manually performed by the user and also electrically performed by a driving apparatus such as a separate motor.

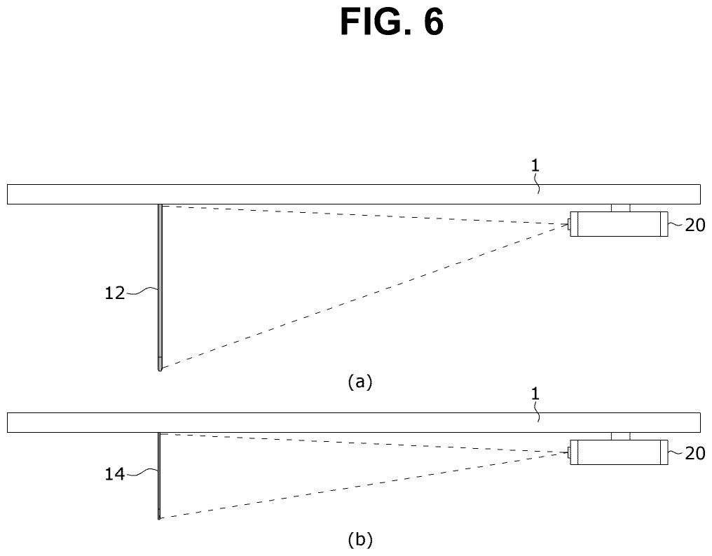

FIG. 6 shows a view illustrating the projector that is controlled according to an arrangement of the first screen and the second screen according to one embodiment of the present invention.

Since the projector assembly according to one embodiment of the present invention includes the first screen 12 and the second screen 14, two modes in which the first screen 12 and the second screen 14 are individually used may be applied.

Accordingly, a plurality of screen modes, which may include, for example, a large screen mode, in which the first screen 12 is rotated and disposed downward from the ceiling 1 when the user wants to use a large screen, and a small screen mode, in which the second screen 14 is rotated and disposed downward from the ceiling 1, may be implemented in the projector assembly. The large screen mode is illustrated in FIG. 6A, and the small screen mode is illustrated in FIG. 6B.

When the large screen mode is implemented, the first screen 12 may rotate downward, and the projector 20 may control a direction of a projected beam to utilize or use the entirety of the first screen 12. The second screen 14 may be seated in the accommodation groove 130 of the first screen 12.

When the small screen mode is implemented, the second screen 14 may rotate downward, and the projector 20 may control the direction of the projected beam to utilize or use the entirety of the second screen 14. The first screen 12 may be seated in the screen groove 2.

The projector 20 may control the direction of the projected beam according to the size and arrangement of the screen 10.

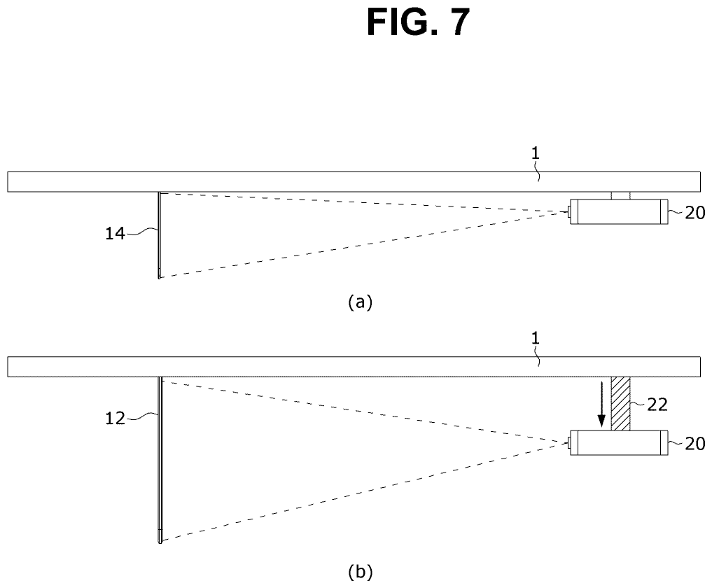

FIG. 7 shows a view illustrating the projector of which a height is adjusted according to one embodiment of the present invention.

Referring to FIG. 7, the projector 20 according to one embodiment of the present invention may be vertically moved from the ceiling 1 to change an arrangement thereof. FIG. 7A is a view corresponding to the small screen mode in which the second screen 14 is used, and FIG. 7B is a view corresponding to the large screen mode in which the first screen 12 is used.

The direction of the beam projected by the projector 20 may be changed according to the size of the screen 10. In the case of the large screen mode in which the first screen 12 is used, the projector 20 may project the beam to a wider range and project the beam toward a lower side than the case of the small screen mode in which the second screen 14 is used.

The projector 20 may vertically move to correspond thereto. In order to implement this, a separate driver 22 may be disposed between the projector 20 and the ceiling 1. The driver 22 may correspond to an actuator, motor, or the like. The driver may be disposed to be inserted into the vehicle ceiling 1. Since the driver 22 is disposed in the vehicle ceiling 1, the projector 20 may be disposed to be in close contact with the vehicle ceiling 1 normally. The projector 20 connected to the driver 22 may vertically move to control the direction of the beam projected to the screen 10.

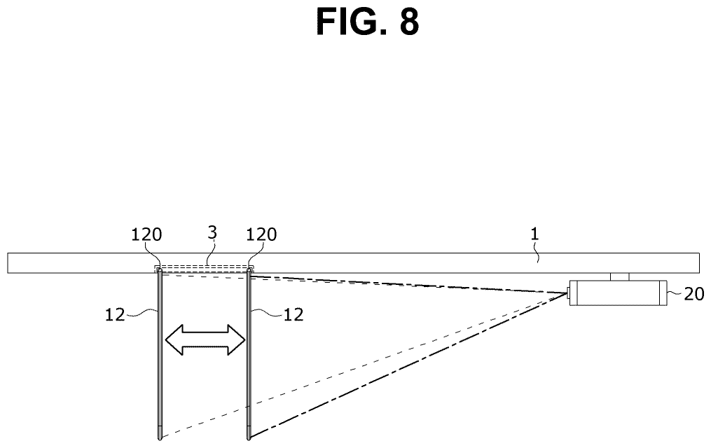

FIG. 8 is a view illustrating the screen that moves forward or rearward according to one embodiment of the present invention.

Referring to FIG. 8, the screen 10 according to one embodiment of the present invention may move forward or rearward. Since the screen 10 may rotate with respect to the hinge, both ends of the hinge may be connected to the moving rails 3 disposed inside the screen groove 2. The hinge may move forward or rearward on the moving rails 3.

The screen 10 may be manually or electrically moved forward or rearward. Since the moving rails 3 are disposed or formed at both sides of the screen groove 2, the moving rails 3 may be formed to correspond to lengths of both side surfaces of the screen groove 2.

The screen groove 2 may be formed to correspond to a size of the first screen 12. Alternatively, the screen groove 2 may be formed to have a greater size than the first screen 12. That is, extra space may be generated when the screen 10 is seated in the screen groove 2. The screen 10 is not seated in the corresponding space. The corresponding space may provide a space to move the screen 10 forward or rearward when the screen 10 is used.

Accordingly, when the screen 10 is accommodated in the screen groove 2, the screen 10 may be rotated and disposed at a position at which an end of the screen groove 2 is in contact with an end of the screen 10 and accommodated in the screen groove 2. The moving rails 3 may be formed in both entire side surfaces of the screen groove 2 or formed in only portions thereof.

When the screen 10 moves forward or rearward as in FIG. 8, the direction of the beam projected by the projector 20 may be adjusted.

The projector 20 may receive information of an arrangement of the screen 10 from the moving rail 3 to automatically adjust the direction of the beam. The projector 20 may receive a position and a rotating angle of the hinge collected by the moving rail 3 to adjust the direction of the projected beam. In order to implement this, the moving rail 3 may include a sensor which detects the position and arrangement of the hinge. A location of the sensor is not limited, and the sensor may be disposed on the moving rail 3, the vehicle ceiling 1, or the projector 20. The projector 20 may sense an arrangement of the screen 10 using the sensor and adjust the direction of the projected beam.

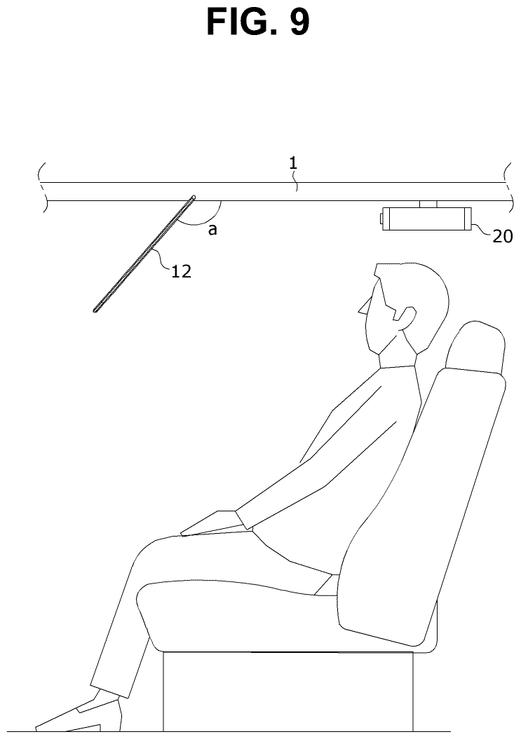

FIG. 9 is a view illustrating the screen that is disposed according to a user's eyes according to one embodiment of the present invention.

As in FIG. 9, the screen 10 and the projector 20 may be disposed in the ceiling 1 in the vehicle room, and the passenger sitting thereunder may watch the screen 10. The passenger may adjust an arrangement of the screen 10 according to a posture of the passenger.

An angle a formed by the screen 10 and the ceiling 1 may be adjusted according to a direction of the passenger's eyes. As in FIG. 9, when the passenger obliquely sits in a reclined seat, the angle a formed by the screen 10 and the ceiling 1 may be an obtuse angle. That is, the screen 10 may be rotated toward a front side of the vehicle and disposed at a certain angle.

The angle of the screen 10 may be manually or electrically adjusted. The passenger may directly manually adjust the angle of the screen 10, or the screen 10 may be electrically rotated at a set angle. A stopper may be provided on the hinge of the screen 10 in order to maintain a corresponding angle when the passenger manually rotates the screen 10. The stopper may serve to hold the hinge to prevent the screen 10 from being inclined by gravity.

According to one embodiment of the present invention, a plurality of screens rotatably provided on a vehicle ceiling can rotate about the same rotation axis and overlap and can be accommodated in a screen groove formed in the ceiling to improve utilization of space and also secure a luxurious appearance.

Various useful advantages and effects of the present invention are not limited to the above-described content and can be more easily understood in the process of describing the specific embodiments of the present invention.

While the present invention has been described above with reference to specific exemplary embodiments, it may be understood by those skilled in the art that various modifications and changes of the present invention may be made within a range not departing from the spirit and scope of the present invention defined by the appended claims.

What is claimed is:

1. A projector assembly comprising:
a screen rotatably attached to a ceiling of a vehicle room; and
a projector disposed on the ceiling of the vehicle room and spaced apart from the screen,
wherein the screen includes a first screen and a second screen smaller than the first screen, the first and second screens being individually rotatable,
wherein the first screen has an accommodation groove on a surface thereof, the accommodation groove having a shape corresponding to that of the second screen, and
wherein the second screen is configured to be seated at the accommodation groove when rotated toward the first screen.

2. The projector assembly of claim 1, wherein:
the first screen includes a pair of first hinges respectively disposed at both sides thereof,
the second screen includes a pair of second hinges respectively disposed at both sides thereof,
the pair of second hinges are respectively disposed inside the pair of first hinges, and
a rotation axe of the first screen is colinear with that of the second screen.

3. The projector assembly of claim 1, wherein the screen is configured, when rotated toward one side, to be seated in a screen groove of the ceiling of the vehicle room such that the screen does not protrude from the ceiling of the vehicle room.

4. The projector assembly of claim 3, wherein the second screen has a thickness corresponding to a depth of the accommodation groove of the first screen.

5. The projector assembly of claim 4, further comprising a pair of moving rails respectively disposed at both sides of the screen groove, wherein ends of the pair of first hinges are movably seated in the pair of moving rails, respectively.

6. The projector assembly of claim 5, wherein:
the projector assembly is configured to operate in one of a plurality of screen modes including:
a large screen mode, in which the first screen is rotated and an image is projected to the first screen through the projector; and
a small screen mode, in which the second screen is rotated and an image is projected to the second screen through the projector, are implemented, and
in the large screen mode, the second screen is rotated with the first screen and seated at the accommodation groove of the first screen.

7. The projector assembly of claim 6, wherein the projector is configured, when switching between the plurality of screen modes, to adjust a direction of a projected beam to utilize an entirety of the screen according to a size of the screen.

8. The projector assembly of claim 7, wherein, when a distance between the screen and the projector is changed by a movement of the screen along the pair of moving rails, the projector is configured to adjust the direction of the projected beam to utilize the entirety of the screen according to a distance from the screen.

9. The projector assembly of claim 8, wherein the projector is attached to the ceiling of the vehicle room and configured to be vertically movable according to the size of the screen and the distance from the screen to adjust a position of the projector.
